(19) United States
(12) Patent Application Publication
(10) Pub. No.: US 2020/0189313 A1
(43) Pub. Date: Jun. 18, 2020

(54) ALL IN THE BAG ART

(71) Applicants: Wilfred Cormier, Las Vegas, NV (US); Maria Escuin, Las Vegas, NV (US)

(72) Inventors: Wilfred Cormier, Las Vegas, NV (US); Maria Escuin, Las Vegas, NV (US)

(21) Appl. No.: 16/218,364

(22) Filed: Dec. 12, 2018

(51) Int. Cl. B44D 3/12; B44D 2/00

(52) U.S. Cl. CPC B44D 3/12; B44D 2/00

(57) ABSTRACT

A method of painting is presented. The method is provided in a container such as a bag. The bag may be plastic. A paint mixture is placed into the plastic bag. The bag is sealed and then one of a plurality of corners of the plastic bag is removed. The plastic bag is squeezed to extract the paint. The corner of the plastic bag may be removed by a tool such as a knife, scissors, etc. The size of the opening in the corner of the plastic bag is useful in determining width of the lines of paint that are placed onto a painting surface.

### FIELD OF THE INVENTION

This invention relates to art supplies. More particularly, it relates to bag of art supplies.

### BACKGROUND

For centuries, artists have been painting with paint brushes as the learned and practiced standard. But may would like to create beautiful paints without the use of any kind of paint brush, but many frown on this method. Also, a method for allowing children and those with disability to participate in art without the worry of creating conditions that are unsafe to the participant.

An artist should be able to produce not only detailed art but also have the ability to create a wide range of unusual textures.

Therefore, there is a need to be able to create stipple, graphic effects, variation of thickness of lines, sewing and embroidered effects without the use of conventional tools.

### BRIEF DESCRIPTION OF THE DRAWINGS

FIG. 1 is an illustrated exemplary bag for art.

FIG. 2 is an illustrated view of the bag of FIG. 1 with paint being added.

FIG. 3 is an illustrated view of the bag of FIG. 2 being sealed.

FIG. 4 is an illustrated view of the bag of FIG. 3 being readied for use.

FIG. 5 is an illustrated view of the bag of FIG. 4 in use.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Referring to FIG. 1, an exemplary bag 100 for art usage is presented. The bag 100 is useful to have the art supplies added to without fear of creating an unsafe and/or messy environment. The bag 100 as shown provides a safe art experience for those with disabilities, mental issues, and/or children.

The bag 100 is has an outside 110 and an inside cavity 120. The bag 100 may be made of any material which may be able to hold liquid material. The bag 10 is preferably strong, durable, reusable and pliable. The bag 100 is preferably made of plastic. The bag 100 may be any type of bag, such as a sandwich bag, a storage bag, etc. Further, the bag 100 may be of any size, preferably six and one half inches by six and one half inches (6.5″×6.5″) but may be of any size which is manageable and useful for any of the participants of the art project. When the bag 100 is conformed to a useful position, the bag 100 may have a plurality of corners 140.

The outside 110 of the bag 100 may be decorated in any desired decoration. The outside 110 of the bag 100 is thus customizable to the user or may carry branding information.

The inside cavity 120 of the bag 100 is accessible via an opening 130 in the bag 100. The opening 130 in the bag 100 is of a size that allows for liquid to be poured into the inside cavity 120 of the bag 100 without allowing excessive spillage. The inside cavity 120 of the bag 100 is of a size which allows for a container of paint or other liquid to be held for the artistic activity.

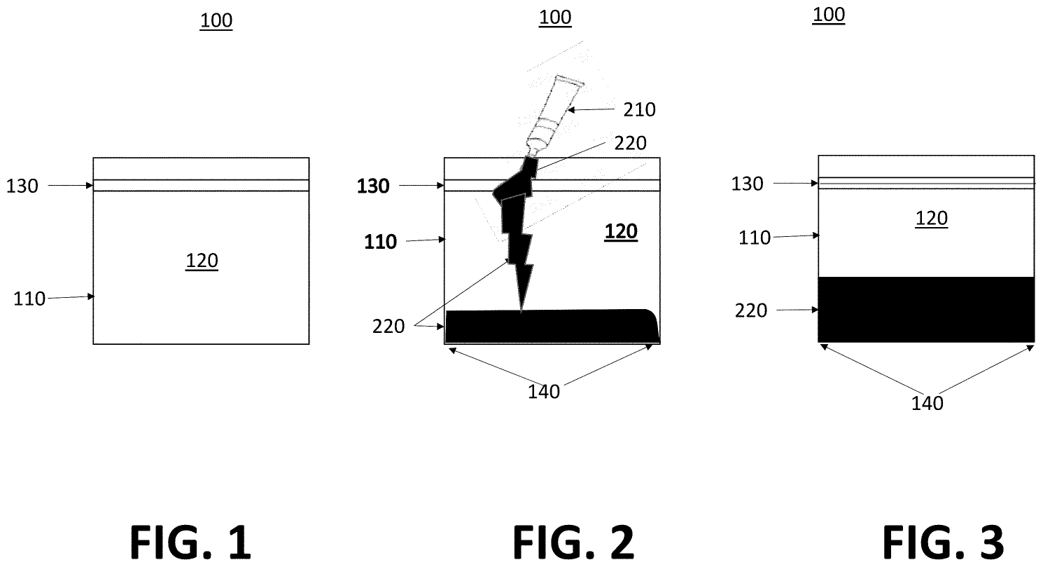

Moving now to FIG. 2, the bag 100 of FIG. 1 is being readied for the art project. The bag 100 may be made of any material which may be able to hold liquid material. The bag 10 is preferably strong, durable, reusable and pliable. The bag 100 is preferably made of plastic. The bag 100 may be any type of bag, such as a sandwich bag, a storage bag, etc. Further, the bag 100 may be of any size, preferably six and one half inches by six and one half inches (6.5″×6.5″) but may be of any size which is manageable and useful for any of the participants of the art project.

A user or teacher desires to fill the bag 100 with paint or other liquid for use in an art project. The user or teacher obtains a container 210 of paint 220. The bag 100 is opened at the opening 130 of the bag 100. The bag 100 is opened manually at opening 130, but opening automatically, mechanically or semi-automatically may occur as determined by one of ordinary skill in the art. The bag 100 is placed on a surface that is flat, stable and secure.

The paint 220 can be any type of paint may be acrylic, latex, liquitex gel, etc., but is preferably a combination of acrylic paint and liquitex gel mediums. The paint 220 may come in a small tube container, as shown in FIG. 2 or may be contained in other container sizes and shapes.

After the bag 100 has been opened at the opening 130, the container 210 is opened and the container is brought to the opening 130 of the bag 100. The container 210 is then squeezed or operated to dispense of the paint 220 contained in the container 210. The paint 220 exits the container 210 and is now contained in the inner cavity 120 of the bag 100.

In FIG. 3, the bag 100 has had the paint 220 from the container 210 of FIG. 2 dispensed into the bag 100. The paint 220 may go through a mixing process before being dispensed into the bag 100. The mixing process may be completed manually with palette knives or other blending utensils. The bag 100 is sealed at the opening 130. The opening 130 may be sealed manually, by use of a tool, or other means. The user may desire to decorate the bag 100 or may wish to denote the ownership or usage of the bag 100. To this end, ornamentation 310 may be attached or otherwise shown to denote the user of the bag 100.

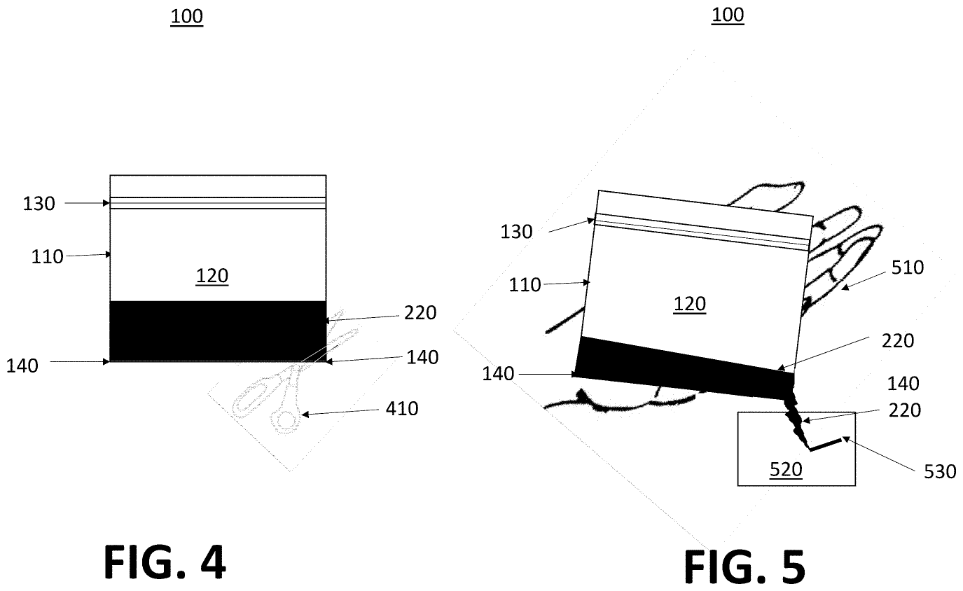

Now referring to FIG. 4, the bag 100 is being prepared to be used by the user. The bag 100 contains paint 220 from the container 210 that was transfered into the bag 100 at its opening 130. The opening 130 has been sealed, preferably manually, at the opening 130 and has been decorated if so desired.

The user obtains a tool 410 to create an egress port for the paint 220 to be used in an art project. The tool is a pair of scissors 410, but may be a knife, a scalpel, etc.

The user, or teacher, then determines one of the plurality of corners 140 of the bag 100 to be used as the exit point for the paint 220. The user or teacher then uses the tool 410 to cut off one of the plurality of corners 140 of the bag 100. The one of the plurality of corners is then torn off to remove the corner material from being a hinderance to the paint 220 being dispensed from the bag 100. The user or teacher may, instead, tear one of the plurality of corners 140 using other means such as manually.

The opening created in the one of the plurality of corners 140 will create the width of the line being drawn. The larger the opening in the one of the plurality of corners 140, the thicker the line will be. Therefore, if the opening created in the one of the plurality of corners 140 is small, then the line will be thin, if the opening in the one of the plurality of corners 140 is large, the line drawn by the dispensed paint 220 will be thicker.

In FIG. 5, the bag 100 is ready to be used for an art project. The bag 100 is placed in a hand 510 of the user. The user or teacher has placed an art receiver 520, such as a piece of art paper, onto a surface or easel for the user to paint on.

The user manually squeezes the bag 100 by gripping the bag 100 with the hand 510 and collapsing the bag 100. Paint 220 is forced from the bag 100 and flows to the art receiver 520 and creates an line 530. It is preferable to first create a small hole in the one of the plurality of corners 140 such that thin lines are first available. For thicker lines, one may decide to either use the tool 410 to create a larger opening in the one of the plurality of corners 140 or may use the tool 410 to tear or cut a different of the plurality of corners 140 to create a larger opening to make thicker lines.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of painting, comprising the steps:
providing a plastic bag;
placing a paint mixture into said plastic bag;
sealing said plastic bag;
creating a hole in one of a plurality of corners of said plastic bag; and
squeezing said plastic bag to paint a line.

2. The method of claim 1, wherein removing one of a plurality of corners of said plastic bag comprises cutting off said one of a plurality of corners with a tool.

3. The method of claim 2, wherein said tool comprises a knife.

4. The method of claim 2, wherein said tool comprises scissors.

5. The method of claim 1, wherein said removing one of a plurality of corners of said plastic bag comprises tearing off said one of a plurality of corners by a user.

6. The method of claim 1, further comprising creating a first paint lines.

7. The method of claim 6, further comprising creating a second paint lines.

8. The method of claim 1, wherein said removing one of a plurality of corners of said plastic bag creates a first corner hole.

9. The method of claim 8, wherein said removing one of a plurality of corners of said plastic bag creates a second corner hole.

10. The method of claim 1, wherein said plastic bag is a sandwich bag.

11. The method of claim 1, wherein said plastic bag is 6.5 inches by 6.5 inches in size.

12. The method of claim 9, wherein the second corner hole being a greater width than the first corner hole.

13. The method of claim 7, wherein the second paint lines being a greater width than the first paint lines.
